(19) United States
(12) Patent Application Publication
(10) Pub. No.: US 2009/0226774 A1
(43) Pub. Date: Sep. 10, 2009

(54) Regenerative Cell

(76) Inventor: Ross Salvatore Friscia, Brooklyn, NY (US)

Correspondence Address: Ross Friscia, 1354 72nd street, Brooklyn, NY, 11228, US

(21) Appl. No.: 11/832,651

(22) Filed: Aug. 2, 2007

(51) Int. Cl. H01M 8/04; H01M 8/18

(52) U.S. Cl. 429/17; 429/19

(57) ABSTRACT

The system disclosed herein is a Closed-Loop, regenerative system in which energy is recycled. It comprises: an electrolysis module and a fuel cell module. The electrolysis module creates hydrogen and oxygen gas by running an electrical current through water. Once these gasses are created, they are transported to the fuel cell module. The fuel cell module then converts these gasses into energy. A portion of the energy created will be directed to the electrolysis module to create the hydrogen and oxygen gas, and a portion will go to a power load. Since the energy created by the system is recycled, the system is therefore closed loop, and regenerative.

This application claims the benefit of the filing date of U.S. Provisional Application Ser. No. 60/773,160, now abandoned.

### FIELD OF INVENTION

This invention relates to electrochemical cell systems, specifically to regenerative electrochemical cell systems.

### BACKGROUND OF INVENTION

1. Objects and Advantages

In recent years, many scientists around the world have affirmed the beliefs and exposed the dangers of Global warming to the public. They warn that if the human population does not change their ways, the world could be on the verge of a massive climate change that will take the lives of many innocent people. Signs of this dreadful forecast have become more self-evident through the 2005 hurricane season. Over 26 of these deadly storms were formed, due to the rise in ocean temperatures, and have caused billions of dollars in damage and cost the lives of many.

Studies have shown that humans are mostly to blame for Global Warming. By burning fossil fuels and oil, we are releasing tons of toxic chemicals and greenhouse gasses into the air. When these greenhouse gasses are released into the environment, they trap the sun's light into the earth by forming a ‘shield’ in our atmosphere, thus letting sunlight enter our atmosphere, but blockading it from exiting. This process is more commonly known as the greenhouse effect, and will eventually lead to Global Warming. Therefore, if we do not find some other “clean” energy source, we may all be pushing ourselves to the brink of disaster.

Currently, the United States and many other nations are becoming “dependent” on foreign oil, due to the ever increasing demands of the public, thus costing their governments hundreds of millions of dollars to supply their nations with the oil that they desperately need. In his 2007 state of the union address, the President of the United States stated that the government needs to find a new source of energy to lift the nation's dependence on foreign oil. Also, if people continue to use oil and fossil fuels at their current rate, the world supply will soon be depleted. Scientists estimate that the world will run out of oil in about fifty years. Therefore, if we continue to use oil and fossil fuels for the next fifty years, the nations of the world could be thrown into a state of turmoil that will last until an effective solution is found.

However, there is hope, for the invention of which is disclosed in this application is a device which will recycle energy and produce NO byproducts that are harmful to the environment in any way! In fact, the only byproduct of the invention is heat. To start the device, I use a fuel; but, unlike oil and fossil fuels, this “fuel” is environmentally friendly and so abundant that it makes up over 70% of the surface of our planet. This fuel is water. My device creates energy from the water, (which can power a myriad of applications), and then takes the energy from the application it is powering and turns it back into water. Therefore, the energy created will be continuously recycled throughout the system. The device (herein “cell”) will be very efficient and can be used to power just as many, (if not more), applications than that of oil and fossil fuels

Also, since the cell recycles the energy it uses, it can save many people a lot of money. Currently, the average American pays two to three dollars (plus) per gallon of gas. These high prices can add up over time, and cost people many thousands of dollars per year. However, with my invention, the only fuel needed is water, and over 90% of it is recycled, therefore saving the average American thousands of dollars which would normally be spent on gas, oil, and fossil fuels.

Since said system is regenerative and so efficient, it has the potential to: Reduce the effects of Global Warming, Provide the population with energy to power a myriad of applications, Save governments billions (or possibly trillions) of dollars from foreign oil, Save the average American many thousands of dollars, and Save the lives of many.

Further objects and advantages of my invention will become apparent from a consideration of the drawings and ensuing description.

2. Brief Description of Related Art

Many other people have taken forth the great challenge of finding a solution to the world's energy crisis and global warming. One of the most looked upon solution is the use of ethanol as a fuel. Since ethanol can be easily obtained from corn, and the supply is “grown back” every year, it does seem apparently resourceful. However, the viability of this “solution” must be evaluated. Even though the supply of corn makes this system somewhat resourceful, it still releases harmful greenhouse gasses into the atmosphere. This type of cell takes a solution of water and ethanol and disassociates it into carbon dioxide and hydrogen. The hydrogen is used to create energy, and the carbon dioxide is let out as “exhaust”. Since carbon dioxide is a major greenhouse gas, ethanol cannot be considered as viable solution. Besides this, one will still have to go to the gas pump and buy ethanol which can, at times, cost as much or more than standard gasoline. How could this system initiate a change when it can cost more than gasoline? What is going to make the average American say that he/she would like to convert to ethanol? Also, ethanol is a very harmful substance which can cause permanent injury or even death.

Ethanol is certainly not the only, or best, solution to be bought up; there are many others. In fact, there is a “zero-emissions” car that runs on hydrogen and air. Yes, it is true that a hydrogen powered vehicle does not let out any greenhouse gas emissions, but there are many other factors to consider. First, you have to (once again) go to the gas station and pay for hydrogen to get pumped into your car. Since the average efficiency of these types of cells range from 30-40%, you will have to go there frequently and get much less for your money. Also, since you don't have a hydrogen pipeline going to your house to power it, and there are barely any hydrogen gas stations, there will be a BIG problem getting your hands on the hydrogen or jumpstarting the “Hydrogen Economy”.

There is one “solution” out there, however, that is not recognized by the general public. This invention is disclosed in U.S. Pat. No. 6,887,601. This system has two different “modes” in which it can operate. The first mode “Electrolysis mode” uses hydrogen fuel cells to perform electrolysis of water to create hydrogen gas. [These fuel cells are the same fuel cells that are used in the ethanol system and the hydrogen powered vehicle.] Once the hydrogen gas is created, it is transported to tanks along with oxygen gas in a separate tank. When the system goes into its second mode “fuel cell mode”, the hydrogen gas and oxygen gas is transformed into energy via the use of more fuel cells. However, when the fuel cell has “attained operating conditions”, it ceases the flow of oxygen from the oxygen tank and introduces oxygen from a surrounding atmosphere to create energy. Once energy is created, water is also created. Some of this water gets put into a water storage tank, and some gets drained out.

There are several problems with this invention. First of all, if a car crashes, (god forbid), tanks of hydrogen and oxygen are NOT going to help much. Having tanks of hydrogen gas in your car is like carrying hydrogen bombs! If even the slightest spark reaches the hydrogen, it will explode violently; and since the gas is contained in metal tanks, it will explode extremely violently! Also, if there is a leak in both the hydrogen and oxygen tanks, the mixture of hydrogen and oxygen gas would become even more volatile! Another problem with this system is that it introduces oxygen from a surrounding atmosphere in substitution of the oxygen created by “Electrolysis mode”. As you might already know, air is not just pure oxygen. It is also a mixture of nitrogen, argon, carbon dioxide, neon, helium, krypton, sulfur dioxide, methane, and MANY MORE unwanted gasses. As you can see, by introducing oxygen from a surrounding atmosphere to your system, you are NOT just introducing oxygen, but also all of the other gasses in the air as well. This can, and will, lower the efficiency of this system by up to 40%!

As you can see, U.S. Pat. No. 6,887,601 is not the most viable “solution” for our energy crisis and global warming problems (due to the fact(s) that it is inefficient and dangerous); nor is any other system as mentioned! As you can also see, the world is in desperate need for a real solution. The real solution has been found and is disclosed within this very patent application.

### SUMMARY OF INVENTION

In a container, a solution of Sodium Hydroxide (NaOH) and Distilled water (H₂O) is placed along with two graphite rods. The graphite rods are connected by way of high gauge stainless steel wires to a Photovoltaic cell. The Photovoltaic cell will store energy from the sun and release it when needed to start the reaction. When energy from the Photovoltaic Cell is directed to the graphite rods in the solution, Hydrogen gas (H₂) at the cathode and Oxygen gas at the anode (O₂) are produced. Along with these two gasses, Sodium Hydroxide (NaOH) is formed at the cathode and Water (H₂O) at the anode. The Chemical Reaction is as follows:

Cathode: Anode:

2Na⁺+2H₂O→2NaOH+H₂ 4OH⁻+2H₂O→4H₂O+O₂

These gasses flow through an interlacement of gas collecting containers and through barbed hose connectors into two separate tubes made of silicon. The tubes are attached to a Proton Exchange Membrane system.

While in the Proton Exchange Membrane (PEM) system, the gasses are transported to the Membrane Electrode Assembly through their respective ports. When a load is attached to the PEM, it causes the Hydrogen gas (H₂) molecules to split up into protons and electrons. The reaction is as follows:

H₂→2H⁺+2e⁻

The electrons flow through the load, and as this is being accomplished, the protons flow through a semi-permeable membrane. The Protons and electrons then meet up on the other side of the membrane and re-form hydrogen gas. The reaction is as follows:

2H⁺+2e⁻→H₂

The Hydrogen gas would then combine with the Oxygen gas to produce water, which would then be redirected back into its original container (with the hydroxide).The reaction is as follows:

2H₂+O₂→2H₂O

By redirecting the water created by the PEM system to the original container, we are, in essence, regenerating the energy created by the system in a closed-loop fashion. [The system is considered closed-loop because none of the original elements of the system are directly exiting the system (they are being recycled), nor are any “new” elements being introduced to the system.]

### DETAILED DESCRIPTION OF THE CURRENT PROTOTYPE

The most current working prototype of my invention is composed of two basic sections. In the first section, a tank (FIG. 126) holds a solution of Sodium or Potassium Hydroxide and Water (FIG. 112). On stands (FIG. 124), two graphite rods (FIG. 110) are attached to solar panels and submerged in the solution. Separately wrapped around each of these rods are thin conductive wires (FIG. 128) which are attached to a power source (preferably solar panel/s: FIG. 512). Covering these rods are two containers (FIG. 114) with barbed hose connectors (FIG. 118) at the top of each container. These barbed hose connectors are connected to tubes (FIG. 116) which are further connected to other barbed hose connectors (FIG. 118a) which are attached to endplates (FIG. 212) the second main section of my invention.

The second section (or proton exchange system) of my invention is a sandwich of parts, first composed of two endplates on each side of the assembly (FIG. 212). On the top of these endplates are insulated binding posts with banana jacks (FIG. 120) which are further attached to a conductive material such as stainless steel (FIG. 216) which runs down the inner side of the endplates. Touching the conductive material is conductive graphite plates with a serpentine flow channel (FIG. 412) on the side opposite the conductive material (FIG. 214). Then, a Membrane Electrode Assembly comprising a number of Nafion membranes (FIG. 312) with a Gas Diffusion Layer on each comprising a platinum loading on the cathode and anode (FIG. 310) is placed next to the plate. The Nafion Membrane is encased in a Mylar surround (FIG. 314), in which to reinforce the Nafion Membrane. Silicon Gasketing is used to separate the Membrane Electrode Assembly from the graphite plates. Thereafter, another graphite plate with serpentine gas flow channels on both sides (FIG. 218) is placed on the remaining side of the Membrane Electrode Assembly; separated by another layer of silicon gasketing. Then, more Membrane Electrode Assemblies followed by a double serpentine graphite plate (FIG. 218) and silicon gasketing are added. Once the last membrane is added, on the side without a plate already on it, another graphite plate (FIG. 214) with only a single gas flow channel, is placed faced down (blank side up) on the last Membrane Electrode Assembly. Finally, conductive material and an insulated binding post on the fiberglass endplate (FIGS. 214, 120, and 212) are added and the sandwich is completed by inserting insulated screws through the parts and tightening everything.

### Theory of Operation of the Current Prototype

There are two (2) theories supporting the operation of the disclosed invention. One theory supports its regenerative principals, while the other claims, through mathematical formulas, that the invention can be made to produce more energy than is put into it.

Theory of Regeneration:

Since water can be split into its original constituents via electrical currents, and its original constituents can be used to create electrical currents, then the two processes can be combined to create a system in which energy is recycled and regenerated in an efficient manner.

Theory of Efficiency:

Since the hydrogen atom contains more energy than that of which is needed to create itself from water, then more energy can be obtained from the hydrogen atom than that of which is needed to power the process needed to create the Hydrogen atom.

Since the second theory may seem highly controversial, it is proven by the following system of mathematical formulas:

1. The internal energy of hydrogen=1.48 volts (Delta H/nₑF, where Delta H is 286 kJ, nₑ is the number of electrons involved in the transformation (2), and F being the faraday constant of 96,500).

2. The theoretical minimum of voltage required to split water=1.23 volts (Delta H/Delta G, wherein Delta G is 236 kJ and Delta H is 286 kJ).

3. Theoretical maximum efficiency=Eₒ/Eᵢ=1.48 v/1.23 v=120.325 . . . %

4. Rate of H₂ production of the disclosed invention=7 cc H2 per minute per ampere @ 1.23 v

5. Energy output of Membrane Electrode assembly of “Fuel Cell”=0.8 v @ 1 A per 7 cc H₂

It may seem at first glance as though, based on this formula, the total efficiency of the disclosed invention would be close to 65%, however, since the voltage in equation 4 is a constant, as you add more membranes, the efficiency can soar up and over 100%.

For example, if a power source is attached to the graphite electrodes in water running at 1.5 volts @ 100 amperes, 700 cubic centimeters of hydrogen gas per minute would be formed. If we then direct this gas to a fuel cell with 100 MEAs (“consuming” 7 cc of H₂/min and putting out 0.8 v @ 1 A per 7 cc H₂) they would take in 700 cc of H₂ per minute and put out 80 volts at 100 amperes. Since efficiency is equal to energy output/energy input (Eₒ/E_{I}), and energy (in this case) is equal to Volts×Amperes, we can calculate the efficiency of my cell to be: (80×100)/(1.5×100) or 5300%.

The reason for this is, (as stated in the Theory of efficiency): there is more energy in a hydrogen atom than is required to split water, and less energy to split water than needed to split the actual molecule of hydrogen gas (442.1 kCal for water as opposed to 52.1 kCal for Hydrogen).

However, the efficiency of the disclosed invention in terms of what it can theoretically put out/what is being put out is actually only close to 54%!

### Operation of Current Prototype

The current working prototype has a variety of functions. First, the solar panel converts light energy into electrical energy. This electrical energy is transported via wires to a set of electrodes in a water and sodium or potassium hydroxide solution (sodium hydroxide will be the example here). The energy causes the water/hydroxide solution to split and form gasses. At the cathode, solid sodium hydroxide and hydrogen gas is formed. At the anode, liquid water and oxygen gas is formed. The chemical reactions are as follows:

Cathode: Anode:

2Na⁺+2H₂O→2NaOH+H₂ 4OH⁻+2H₂O→4H₂O+O₂

The gasses formed are transported into opposite sides of a Membrane Electrode Assembly, (herein MEA), via tubes, containers, and barbed hose connectors. Once a load is placed on the MEA, it causes the hydrogen gas to split into protons and electrons.

The chemical reaction is as follows:

H₂→2H⁺+2e⁻

Once split, the electrons flow through the load via conductive graphite plates, a conductive material (mostly stainless steel foil), insulated binding posts with banana jacks, and wires. At this time, the hydrogen protons travel through a Nafion membrane to the oxygen side of the MEA. Afterwards, the flow of electrons travels back out of the load to the oxygen side of the MEA also. The electrons then re-combine with the hydrogen protons. The chemical reaction is as follows:

2H⁺+2e⁻→H₂

Shortly afterwards, the hydrogen gas re-combines with the oxygen gas to form water vapor. The chemical reaction is as follows:

2H₂+O₂→2H₂O

The water created would then condense into liquid and would then be redirected into the original tank of the water/hydroxide solution where it would then be re-split and the process would start again.

### Scope of Invention

The invention disclosed and claimed in this patent should not be construed as its final, most viable form. Rather, the invention claimed is actually in its simplest form! It is meant to be improved and built upon with new ideas that would it more viable for commercial and residential use. However, the idea of the regeneration of energy from hydrogen and water is the main function of the cell and should be kept constant, for that is the main theory and idea of the invention. For example, the drawings disclosed show a large tank filled with water and electrolyte solution, and the hydrogen fuel cells. This is obviously not going to be the absolute finalized product of the invention. However, that model is the only one that available funds allowed at the time. When and if patent rights are secured, available funding will become easier to obtain in large enough amounts that would allow the rigorous testing and major improvements of the invention, and, hopefully, the residential, commercial, and national integration of the system. One can realize that what is really being patented is a great idea embodied in its simplest form (because of lack of funds). Therefore what should be scrutinized in this application is really the idea and process behind the idea, not its physical form.

### DESCRIPTION OF DRAWINGS

FIG. 1 shows the entire system.

FIG. 2 shows the Fuel Cell module.

FIG. 3 shows a membrane electrode assembly.

FIG. 4 shows a graphite plate with a serpentine flow channel.

FIG. 5 shows solar panels.

### REFERENCE NUMERALS

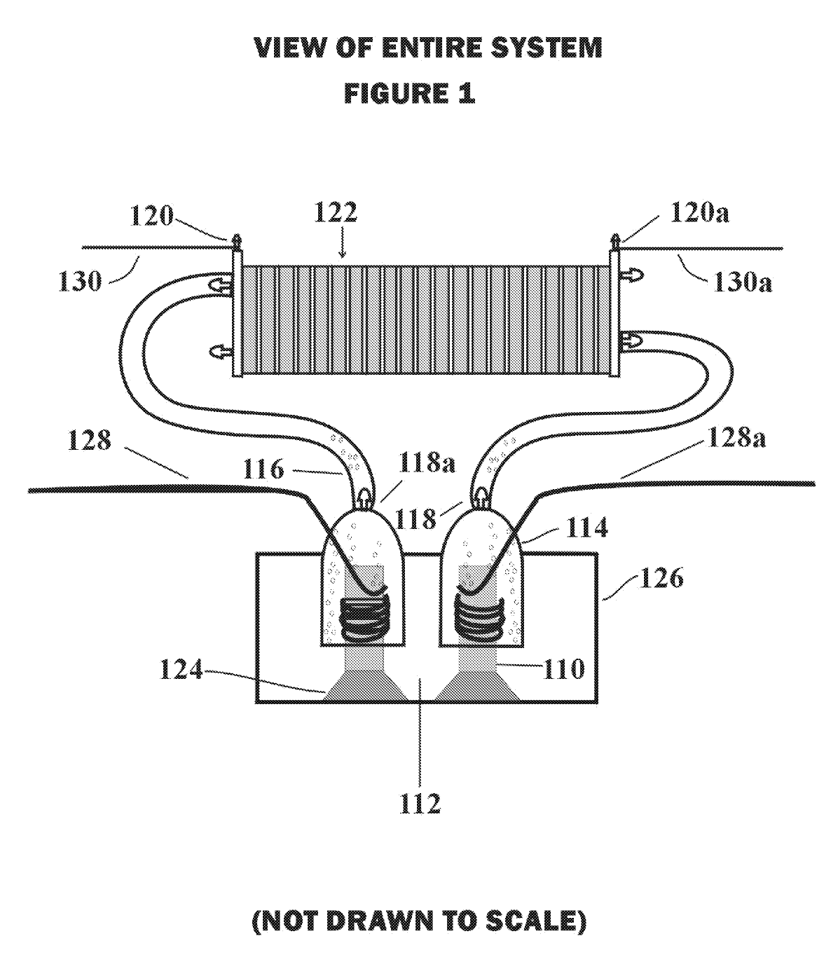

FIG. 1: View of Entire System
110—Graphite Rod
112—Solution of Water and Hydroxide
114—Gas Collecting Containers
116—Tubing
118—Barbed Hose Connectors
120—Insulated Binding Posts with Banana Jacks
122—Fuel Cell System
124—Stands for Graphite Rods
126—Non-Conductive Tank
128—Non Corrosive Wires
130—Non Corrosive Wires

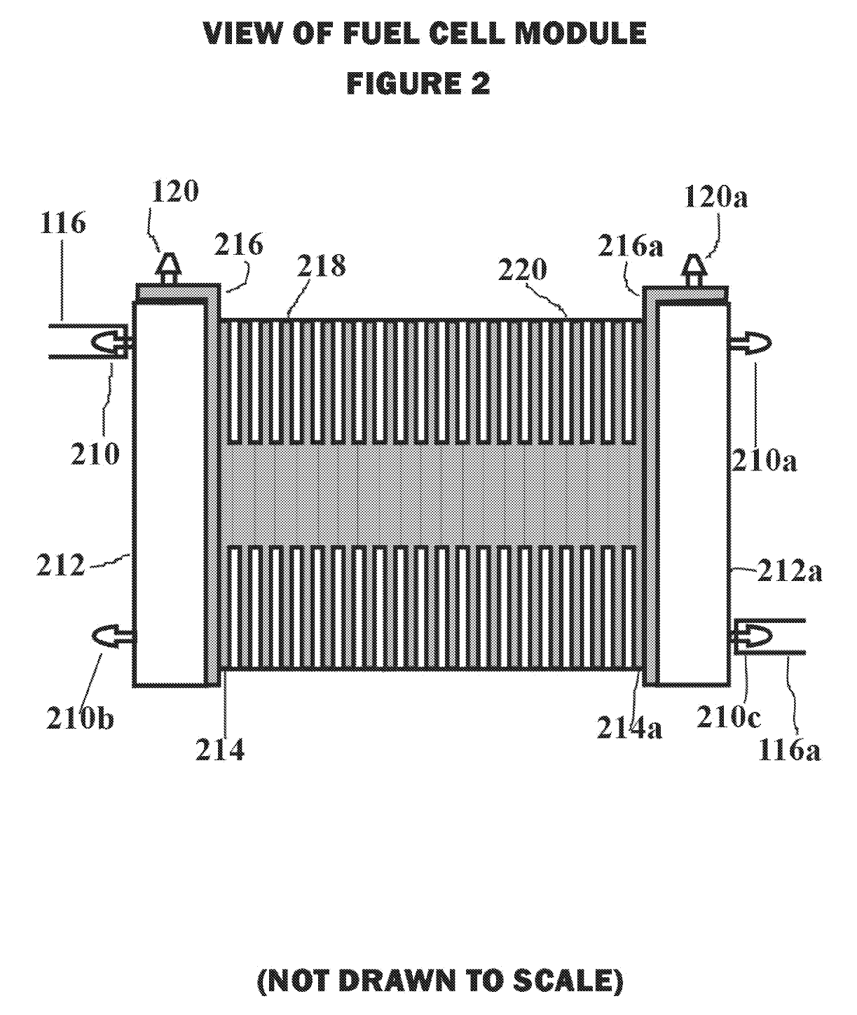

FIG. 2: View of Fuel Cell System
210—Barbed Hose Connectors
212—End Plates
214—Graphite Plates with Serpentine Flow Channel on One Side
216—Conductive Material
218—Graphite Plates with Serpentine Flow Channel on Both Sides
220—Membrane Electrode Assembly

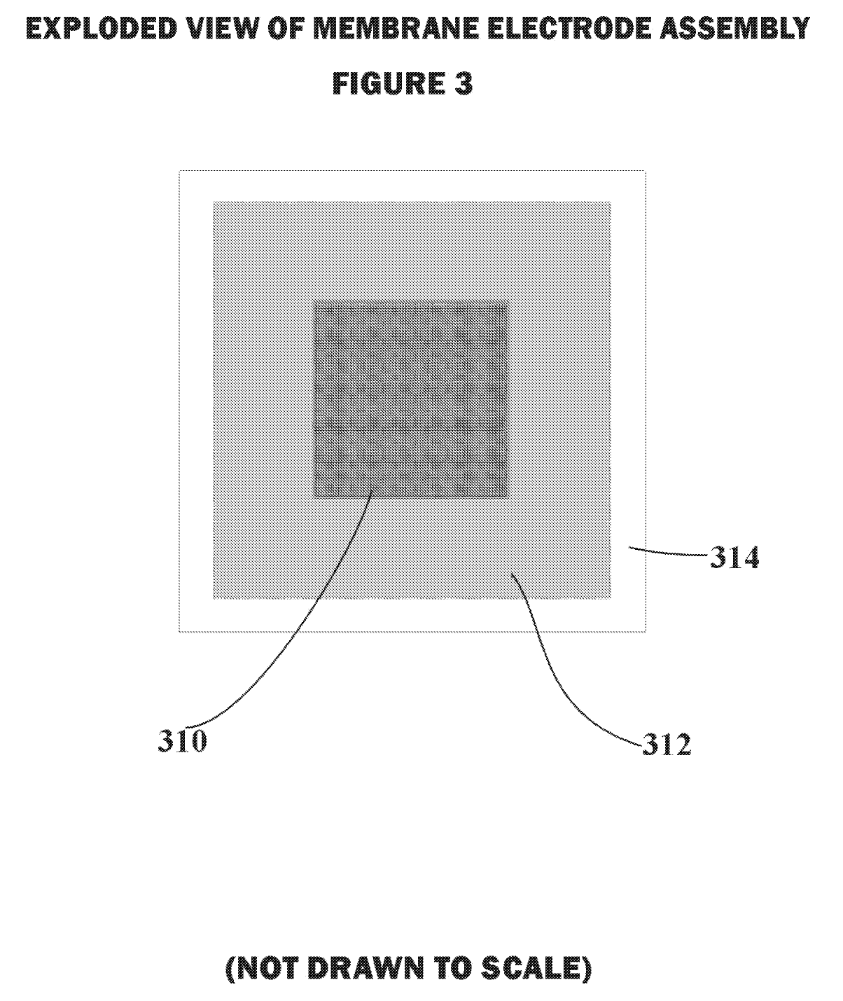

FIG. 3: Exploded View of Membrane Electrode Assembly
310—Gas Diffusion Material
312—Nafion Membrane
314—Mylar Sheet

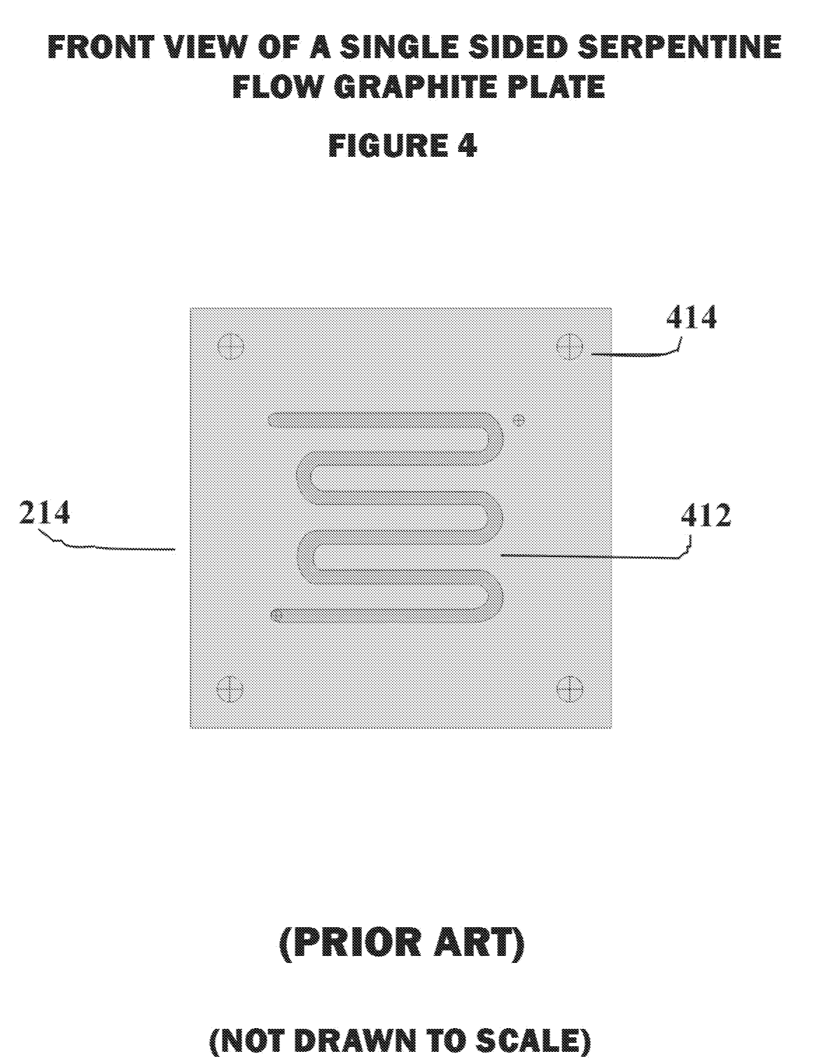

FIG. 4: Front View of a Single—sided Serpentine Flow Graphite Plate
510—Hole
512—Serpentine Flow Channel

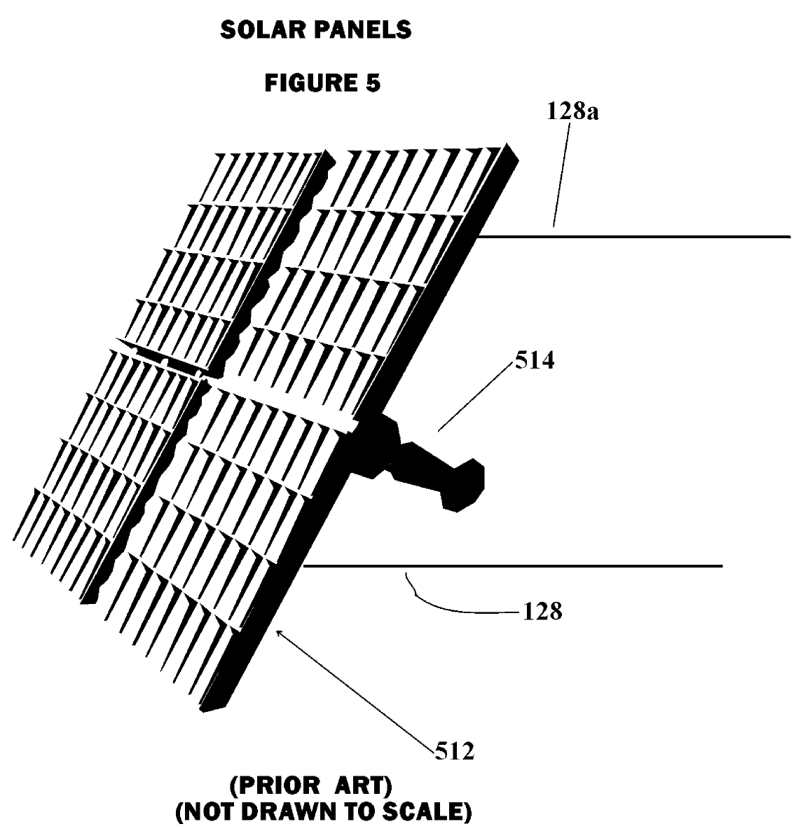

FIG. 5: Solar Panels
510—Solar Panel
512—Stand

What is claimed is:

1. A system comprising:
(a) a process in which water and electrolyte are transformed into gasses via energy, and
(b) a process in which said gasses are converted into energy and back into water in which
(c) the two processes are combined to create one regenerative, closed loop process.

2. Said energy of claim 1 element (b) being directed to several power loads comprising:
(a) the process of claim 2 element (a),
(b) a number of other power loads.

3. Said first process of claim 1 element (a), comprising:
(a) water and electrolyte solution,
(b) a container in which to hold said water and electrolyte,
(c) electrically charged conductive electrodes,
(d) a means in which said gasses are transported to the secondary device in claim 2.

4. Said electrolyte of claim 3, which is a hydroxide.

5. Said gasses of claim 1 comprising:
(a) hydrogen gas, and
(b) oxygen gas.

6. Said electrodes of claim 3, composed of graphite or a metal.

7. Said means of claim 3, comprising:
(a) a container in which gasses are collected separately and transported to
(b) tubes, which are connected to said second device in claim 2.

8. Said conductive electrodes of claim 3, further comprising a power source in electrical connection with said conductive electrodes.

9. Said power source comprising solar panels or other renewable energy source.

10. Said second device of claim 1 comprising a fuel cell module.

11. Said fuel cell module of claim 10 comprising a proton exchange membrane system; whereby, hydrogen gas is transformed into energy and the energy created is recycled and transformed back into hydrogen gas, and into water through recombination of hydrogen with oxygen in an efficient manner.

12. Said proton exchange membrane system of claim 11 comprising:
(a) non-conductive endplates,
(b) one or more membrane electrode assemblies,
(c) conductive graphite plates,
(d) a means of transporting electricity created by said proton exchange membrane system to one or more power loads.

13. A means of creating energy from water comprising:
(a) a process in which water and electrolyte are transformed into gasses via energy, and
(b) a process in which said gasses are converted into energy and back into water in which
(c) the two processes are combined to create one regenerative, closed loop process.
